(19) United States
(12) Patent Application Publication
(10) Pub. No.: US 2026/0321495 A1
(43) Pub. Date: Oct. 15, 2026

(54) SINTERED BODY, METHOD OF MANUFACTURING SINTERED BODY, AND APPLICATIONS THEREOF

(71) Applicants: HYUNDAI MOTOR COMPANY, SEOUL (KR); KIA CORPORATION, SEOUL (KR); The Industry & Academic Cooperation in Chungnam National University (IAC), Daejeon (KR)

(72) Inventors: Bo Kyeong Han, Hwaseong-si (KR); Jae Ryung Lee, Hwaseong-si (KR); Jong Hyeon Lee, Sejong-si (KR); Sung Hyun Park, Daejeon (KR)

(73) Assignees: HYUNDAI MOTOR COMPANY, SEOUL (KR); KIA CORPORATION, SEOUL (KR); The Industry & Academic Cooperation in Chungnam National University (IAC), Daejeon (KR)

(21) Appl. No.: 19/286,749

(22) Filed: Jul. 31, 2025

(30) Foreign Application Priority Data
Apr. 10, 2025 (KR) 10-2025-0046509

(51) Int. Cl. H01G 4/10; B22F 1/00; B22F 1/06; B22F 3/16; B22F 3/24; H01G 9/052

(52) U.S. Cl. CPC H01G 4/10; B22F 1/06; B22F 1/09; B22F 3/16; B22F 3/24; H01G 9/0525

(57) ABSTRACT

A sintered body including a compound having a perovskite structure and a dopant, and exhibiting electrical conductivity of 800 S/m or more at 900° C. The sintered body has application as an anode material and which can be used in methods for electrowinning a target metal. The sintered body can exhibit substantial inertness and excellent electrical conductivity, can maintain a stable anode potential and mechanical strength, and/or can provide high resistance to electrochemical stress.

### CROSS-REFERENCE TO RELATED APPLICATION

This application claims, under 35 U.S.C. § 119 (a), the benefit of priority from Korean Patent Application No. 10-2025-0046509, filed on Apr. 10, 2025, the entire contents of which are incorporated herein by reference.

### FIELD

The present disclosure relates to a sintered body, a method of manufacturing a sintered body, and applications thereof.

### BACKGROUND

In a metal electrowinning process, a graphite material with excellent electrical conductivity and processability has been used for an anode. However, graphite materials are associated with several challenges, such as high consumption rate in high-temperature oxidizing environments and emission of large amounts of carbon dioxide during use. As such, development of an inert anode material to replace the carbon-based anode is desirable.

Several alternative materials may be applied as inert anode materials, but also present challenges. For example, ceramic-based materials are brittle and are prone to cracking under mechanical or thermal shock, and are difficult to process into a shape with an appropriate size in a large-scale process, making such materials generally difficult to use. Also, most ceramics are insulating or have low electrical conductivity and are unsuitable as anode materials when used alone. Even conductive types of ceramics, such as NiO or SiO₂, typically fall short of suitable operating parameters for anode materials, even after treatment to further improve electrical conductivity.

Other composite materials made of ceramics and metals, so-called cermet-based materials, lack processability and durability, and likewise have limitations in scaling up to large-scale processes. Moreover, in a high-temperature electrolytic environment, metal components may be selectively corroded or oxidized by molten salt (electrolyte), making long-term use difficult.

Alloy-based materials have excellent electrical conductivity, but oxidation and corrosion occur rapidly in high-temperature, oxygen-generating molten salt environments. This not only reduces the purity of the target metal to be electrowon, but also shortens the lifespan of the anode.

Accordingly, there remains a need to develop an inert anode material for electrowinning that is capable of alleviating at least these aforementioned problems.

### SUMMARY

In a general sense, the present disclosure addresses problems encountered in the related art such as, for example, those discussed herein. In an aspect, the present disclosure provides a sintered body in which a dopant is added to a compound having a perovskite structure. In another aspect, the disclosure provides for the application and use of the sintered body as an electrode material.

Various aspects of the disclosure provide an electrode material capable of minimizing carbon generation and economically electrowinning a target metal (e.g., materials and methods comprising the sintered body in accordance with the disclosure).

It will be appreciated by those skilled in the art that the various aspects, embodiments, and advantages provided by the disclosure are not limited to the foregoing. Various aspects and embodiments will be able to be clearly understood through the following description and to be realized by the means described in the claims and combinations thereof.

In an aspect, the disclosure provides a sintered body including a compound having a perovskite structure and a dopant, and which has an electrical conductivity of 800 S/m or more measured at 900° C.

In an aspect, the disclosure provides an electrode material and/or associated methods for electrowinning a metal such as, for example, neodymium, comprising a sintered body including a compound having a perovskite structure containing neodymium, an alkali metal oxide, and an alkaline earth metal oxide.

In an aspect, the disclosure provides a method of manufacturing a sintered body, including preparing a compound having a perovskite structure, adding a first dopant and a second dopant to the compound having the perovskite structure to form a mixture, and manufacturing the sintered body from the mixture. In some embodiments, the manufacturing comprises molding and sintering the mixture.

In an aspect, the disclosure provides a method of electrowinning a target metal, comprising providing a device including a first electrode including the sintered body described above, a second electrode facing the first electrode, an electrolyte in contact with the first electrode and the second electrode, and a target metal-containing material added to the electrolyte, and electrodepositing the target metal onto the second electrode by application of a voltage difference between the first electrode and the second electrode.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows the common logarithm values of electrical conductivity (ohm⁻¹·cm⁻¹) depending on the temperature index (1000/absolute temperature) of Examples and Comparative Examples;

FIG. 2 shows scanning electron microscopy results (left) and image results (right) of Comparative Example 2;

FIG. 3 shows results of distribution of each element by energy dispersive X-ray spectroscopy (EDS) of Comparative Example 2;

FIG. 4 shows the atomic percentage of each element depending on the positions (1 to 11) indicated in the scanning electron microscopy results of FIG. 2;

FIG. 5 shows scanning electron microscopy results (left) and image results (right) after electrowinning under the test conditions of Comparative Example 2;

FIG. 6 shows results of distribution of each element by energy dispersive X-ray spectroscopy (EDS) after electrowinning under the test conditions of Comparative Example 2;

FIG. 7 shows the atomic percentage of each element depending on the positions (1 to 11) indicated in the scanning electron microscopy results of FIG. 5 after electrowinning under the test conditions of Comparative Example 2;

FIG. 8 shows the potential difference of each electrode compared to a reference electrode (W) per hour at a current density of 100 mA/cm² according to Test Example; and

FIG. 9 shows the potential difference of each electrode compared to a reference electrode (W) per hour at a current density of 150 mA/cm² according to Test Example.

### DETAILED DESCRIPTION

The above and other aspects, features and advantages of the present disclosure will be more clearly understood from the following detailed description and embodiments in combination with the accompanying drawings. However, various aspects are not limited to the embodiments disclosed herein, and may be modified into different forms. These embodiments are provided to thoroughly illustrate and explain several aspects and embodiments of the disclosure and to explain the spirit of the present disclosure to those skilled in the art.

It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Herein, a comma “,” may be interpreted as “and” or “or” depending on the context, and if elements separated by commas end with “or”, the comma may be interpreted as “or”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

### Sintered Body A

In accordance with aspects and embodiments of the disclosure, a sintered body may include a compound having a perovskite structure and a dopant, and may have electrical conductivity of 800 S/m or more measured at 900° C.

As discussed herein, the sintered body may be applied as an electrode material for electrowinning a metal, and for example, may be applied as an anode material for electrowinning the metal included in the compound having the perovskite structure.

In embodiments, the compound having the perovskite structure may have a structure substantially similar to a CaTiO₃ crystal structure, such as ABX₃ or its modification, AₙAₘ′B₀Bp′X_{3-d}, in which A and B correspond to different metal cations, X corresponds to an anion, and values of n, m, o, p, and d may be set so as to have a stoichiometric molar ratio that satisfies electrical neutrality (i.e., charge balance).

In embodiments, the compound having the perovskite structure may include a first metal (A) comprising one or more of scandium, yttrium, and/or a lanthanide metal having an atomic number from 57 to 71 (e.g., lanthanum, cerium, praseodymium, neodymium, promethium, samarium, europium, gadolinium, terbium, dysprosium, holmium, erbium, thulium, ytterbium, or lutetium); a second metal (B) comprising one or more transition metals (e.g., Groups 4 to 12 and Periods 4 to 6 in the periodic table) different from the first metal; and oxygen as the anion (X). In embodiments, the first metal and the second metal may be used in combination to form a hexavalent cation, and the second metal may include one or more of chromium, manganese, iron, ruthenium, and/or cobalt.

In some embodiments, the compound having the perovskite structure may be NdCrO₃, LaCrO₃, YCrO₃, CeCrO₃, PrCrO₃, and the like. In yet further embodiments, the compound may be NdCrO₃.

In some embodiments, the dopant may be in a state of substituting the site A in the sintered body or being dispersed in the interstitial space through the sintering process, such as, for example, through particle diffusion-densification, along with the compound having the perovskite structure (ABX₃).

In embodiments, the dopant may include a first dopant and a second dopant. In some further embodiments, the first dopant may include an alkali metal oxide, and the second dopant may include an alkaline earth metal oxide.

In some embodiments, the alkali metal oxide may include one or more of lithium oxide (Li₂O), sodium oxide (Na₂O), and/or potassium oxide (K₂O). In some embodiments, the alkaline earth metal oxide may include one or more of calcium oxide (CaO), beryllium oxide (BeO), and/or magnesium oxide (MgO). In some embodiments, the first dopant may include lithium oxide (Li₂O), and the second dopant may include calcium oxide (CaO).

Based on a total of 100 mol % of the sintered body, in some embodiments, the molar amount of the first dopant may be 0.5 mol % to 7 mol %, or in some further embodiments from 0.8 mol % to 5.5 mol %. In embodiments wherein the molar amount of the first dopant falls within the above ranges, one or more of long-term durability may be obtained and electrical conductivity may be improved based on application to an anode material for electrowinning. In some embodiments, the molar amount of the second dopant may be 10 mol % to 25 mol %, or in some further embodiments from 12 mol % to 23 mol %. In embodiments wherein the molar amount of the second dopant falls within the above ranges, one or more of an appropriate sintering density may be obtained and electrical conductivity may be improved.

In some embodiments, the sintered body may have electrical conductivity (electronic conductivity) of 800 S/m or more, in further embodiments 1000 S/m or more, in yet further embodiments 1100 S/m or more, and in even further embodiments 2000 S/m or less when measured at 900° C. In embodiments wherein the above electrical conductivity range is achieved, good efficiency may be obtained based on application to an anode material for electrowinning.

In some embodiments, the electrical conductivity may be measured by the method described in Test Example below.

Without being limited by theory or mechanism, sintering of a material including the compound having the perovskite structure (as described herein) alone makes it difficult to obtain electrical conductivity in the above range, and sintering of the material by further including the dopant makes it possible to realize electrical conductivity greater than or equal to a predetermined value.

The sintered body may be manufactured by any method known in the art, and for example, according to the manufacturing method described below.

### Sintered Body B

In accordance with aspects and embodiments of the disclosure, an electrode material for electrowinning (e.g., neodymium) may include a sintered body including a compound having a perovskite structure containing neodymium, an alkali metal oxide, and an alkaline earth metal oxide.

In some embodiments, the electrode material may be an anode material.

In some embodiments, the compound having the perovskite structure containing neodymium may be, for example, NdCrO₃.

In some embodiments, the alkali metal oxide may be the first dopant described above, and the alkaline earth metal oxide may be the second dopant described above. Any redundant description of the molar ratios, specific components, etc. thereof is not repeated in this section.

In some embodiments, the electrode material may have electrical conductivity of 800 S/m or more, in some embodiments, 1000 S/m or more, or in further embodiments 1100 S/m or more, and/or in yet further embodiments 2000 S/m or less when measured at 900° C. In embodiments wherein the above electrical conductivity range is achieved, good efficiency may be obtained based on application to an anode material for electrowinning neodymium.

### Method of Manufacturing Sintered Body

In accordance with aspects of the disclosure, a method of manufacturing a sintered body may include preparing a compound having a perovskite structure, adding a first dopant and a second dopant to the compound having the perovskite structure in any order to form a mixture, and manufacturing the sintered body described above by molding and sintering the mixture to which the first dopant and the second dopant are added. In another aspect of the disclosure, a method of manufacturing a sintered body may include providing a mixture comprising a compound having a perovskite structure, a first dopant, and a second dopant, and manufacturing the sintered body from the mixture. In some further embodiments, the manufacturing comprises molding and sintering the mixture.

As the compound having the perovskite structure is in accordance with the aspects and embodiments of the disclosure as described in the sintered body above, a redundant description is not repeated.

In embodiments, adding the first dopant and the second dopant to the compound having the perovskite structure may be performed in a manner in which any one dopant is added and then the remaining dopant is added or both dopants are added simultaneously. Further, any techniques, means, or method that provides and satisfies the molar ratio of the first dopant and the second dopant may be applied without any particular limitation.

In some embodiments, the first dopant may be added to the compound having the perovskite structure and then the second dopant may be added. In some embodiments, the second dopant may be added and then the first dopant may be added. In some embodiments, the first dopant and the second dopant may be added simultaneously.

The components of the first dopant and the second dopant are the same as described herein above.

In some embodiments, the first dopant may be added so that the molar amount of the first dopant is 0.5 to 7 mol % based on a total of 100 mol % of the sintered body, and the second dopant may be added so that the molar amount of the second dopant is 10 to 25 mol % based on a total of 100 mol % of the sintered body.

In some embodiments, the first dopant may be added so that the molar amount of the first dopant is 0.8 mol % to 5.5 mol % based on a total of 100 mol % of the sintered body, and the second dopant may be added so that the molar amount of the second dopant is 12 mol % to 23 mol % based on a total of 100 mol % of the sintered body.

In embodiments comprising addition of the first dopant and the second dopant in the above molar amounts, one or more of an appropriate sintering density of the manufactured sintered body may be ensured, electrical conductivity may be improved, and long-term durability may be exhibited based on application to an anode material for electrowinning.

In some embodiments, the molding of the mixture to which the first dopant and the second dopant are added may be carried out in a typical manner, and for example, a green body may be formed by placing the mixture in a mold, and a rod or plate shape suitable for an electrode material may be formed.

In some embodiments, after molding the mixture to which the first dopant and the second dopant are added, sintering may be performed at a temperature of 1500° C. to 1700° C., or in some further embodiments at 1550° C. to 1650° C. In embodiments falling within the above temperature range, a sintered body having an appropriate degree of densification may be manufactured and desired electrical conductivity may be obtained.

In some embodiments, the sintering time may be 1 hour to 100 hours, or in some further embodiments 2 hours to 50 hours.

In some embodiments, the atmosphere during sintering may be an inert gas atmosphere, and in some further embodiments, the inert gas may be argon, helium, neon, or the like.

In some embodiments, the method of manufacturing the sintered body may further include hot-pressing the manufactured sintered body after sintering.

In some embodiments, the sintered body thus manufactured may have the electrical conductivity described above.

### Method of Electrowinning Metal

In accordance with additional aspects and embodiments of the present disclosure, a method of electrowinning a metal may include preparing a device including a first electrode including the sintered body as described herein, a second electrode facing the first electrode, an electrolyte in contact with the first electrode and the second electrode, and a target metal-containing material added to the electrolyte; and performing electrowinning by electrodepositing the target metal onto the second electrode by application of a voltage difference between the first electrode and the second electrode.

In embodiments of the method, the first electrode may be an anode, and the second electrode may be a cathode. In some embodiments, the anode and the cathode may be in accordance with an anode and/or a cathode as generally known in the art, or in some preferred embodiments, in accordance with the aspects and embodiments of the disclosure relating to e.g., an anode.

In some embodiments, the device may include a power supply connected to the first electrode and the second electrode, and the power supply may serve to apply a voltage difference between the electrodes during electrowinning.

In some embodiments, the device may include a space that accommodates the target metal-containing material added to the electrolyte, and may include a crucible.

In some embodiments, the second electrode may include a material that facilitates creation of a voltage difference with the first electrode and electrodeposition of a target metal. Some non-limiting examples of the material include iron, an iron alloy, tungsten, molybdenum, and the like.

In some embodiments, during electrowinning, a carbon-based material may not be substantially generated at the first electrode.

In various embodiments, the target metal-containing material may be a compound containing the target metal, may be a stable or metastable compound in which the target metal is present in a mineral or the like, or may be a target metal oxide. For example, the target metal-containing material may be an oxide of the first metal described above, and may be, for example, neodymium oxide (Nd₂O₃).

In embodiments wherein the target metal-containing material comprises neodymium oxide, the electrolyte may include neodymium fluoride (NdF₃) and may further include at least one of lithium fluoride (LiF), barium fluoride (BaF₂), or calcium fluoride (CaF₂).

In some example embodiments, an electrolyte including the target metal-containing material may include a ternary material of NdF₃—LiF—Nd₂O₃. In accordance with such embodiments, the amounts of the materials in the electrolyte may be 60 wt % to 66 wt % of NdF₃, 32 wt % to 38 wt % of LiF, and 0.1 wt % to 2.5 wt % of Nd₂O₃.

In some embodiments, during electrowinning the temperature of the electrolyte may be 1000° C. or less, or in some embodiments, 900° C. or less, and some further embodiments, 700° C. or more. When embodiments of the method comprise this temperature range, NdF₃ and LiF may be in a molten salt state, and Nd₂O₃ may be in a dissolved (ionized) state.

A better understanding of the present disclosure may be obtained through the following examples and comparative examples. However, these examples merely serve to illustrate certain example embodiments of the broader disclosure, are not to be construed as limiting to the scope or technical spirit of the disclosure.

### Example 1

Neodymium oxide (Nd₂O₃) powder and chromium oxide (Cr₂O₃) powder were mixed in a molar ratio of 1:1 followed by wet ball milling with ethanol as a solvent and polyvinylpyrrolidone (PVP) as a binder. Thereafter, heat treatment was performed at 1200° C. for 10 hours to obtain NdCrO₃ powder having a particle size of 10 μm, followed by dry ball milling, finally obtaining NdCrO₃ powder having a particle size of 1 μm or less.

A first mixture was prepared by adding NdCrO₃ (powder as prepared above) and CaO having a particle size of 1 μm or less in a molar ratio of 8:2 (19.4 mol % of CaO based on the total material). A second mixture was prepared by adding to the first mixture Li₂O having a particle size of 1 μm or less in an amount of 3 mol % (2.91 mol % of Li₂O based on the total material) based on 100 mol % of the first mixture.

The second mixture was molded into a predetermined shape, placed in a sintering furnace, and sintered at a temperature of 1600° C. in an argon atmosphere for 10 hours, thereby obtaining a sintered body.

### Example 2

A sintered body was manufactured under the same conditions as in Example 1, with the exception that a second mixture was prepared by adding to the first mixture 5 mol % of Li₂O (19 mol % of CaO and 4.76 mol % of Li₂O based on the total material) based on 100 mol % of the first mixture.

### Example 3

A sintered body was manufactured under the same conditions as in Example 1, with the exception that a second mixture was prepared by adding to the first mixture 1 mol % of Li₂O (19.8 mol % of CaO and 0.99 mol % of Li₂O based on the total material) based on 100 mol % of the first mixture.

### Comparative Example 1

A sintered body was manufactured in a manner in which NdCrO₃ powder obtained in Example 1 and Li₂O were added in a molar ratio of 7.8:2.2, molded into a predetermined shape, placed in a sintering furnace, and sintered under the same time and temperature conditions as in Example 1.

### Comparative Example 2

A sintered body was manufactured in a manner in which NdCrO₃ powder obtained in Example 1 and CaO were added in a molar ratio of 8:2, molded into a predetermined shape, placed in a sintering furnace, and sintered under the same time and temperature conditions as in Example 1.

The conditions of Examples and Comparative Examples are shown in Table 1 below.

TABLE 1

| | Molar amount of | Molar amount of |
|---|---|---|
| | CaO based on total | Li₂O based on total |
| Sample ID | material (mol %) | material (mol %) |
| Example 1 | 19.4 | 2.91 |
| Example 2 | 19 | 4.76 |
| Example 3 | 19.8 | 0.99 |
| Comparative Example 1 | — | 22 |
| Comparative Example 2 | 20 | — |

### Test Example—Measurement of Electrical Conductivity of Sintered Body

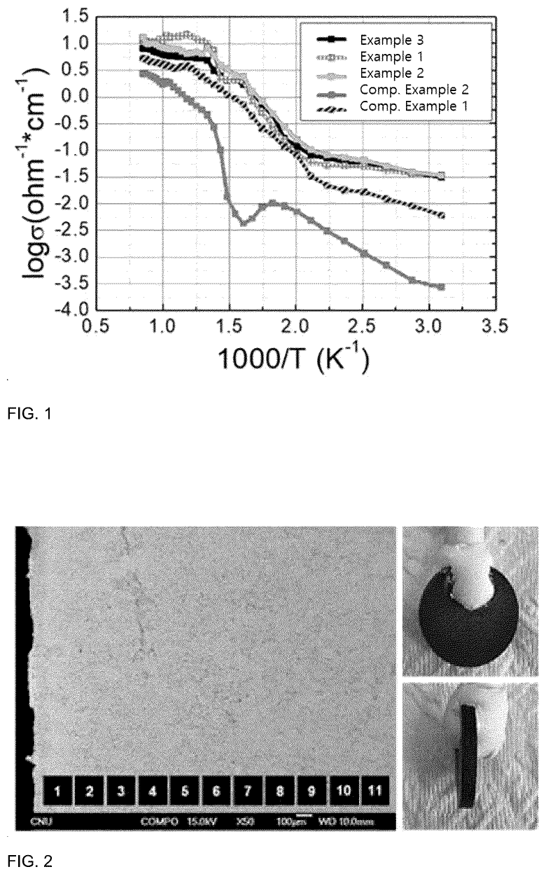

Silver (Ag) paste was applied onto the sintered body manufactured in each of Examples and Comparative Examples and electrical conductivity was measured from room temperature to 900° C. using a 4-point probe method, with the results shown in FIG. 1 and Table 2 below.

TABLE 2

| | Electrical conductivity |
|---|---|
| Classification | at 900° C. (S/m) |
| Example 1 | 1111 |
| Example 2 | 1282 |
| Comparative Example 1 | 521 |
| Comparative Example 2 | 270 |

Referring the Figure and Table, Examples in which the first dopant and the second dopant were added in a predetermined molar ratio showed that electrical conductivity at 900° C. (1000/T=0.85) and electrical conductivity near room temperature (1000/T=3.1) were high when compared to Comparative Examples. This suggests that the first dopant and the second dopant positively contributed to the sintering properties and electrical conductivity.

### Test Example—Analysis of Electrowinning Results Using Sintered Body as Anode Material

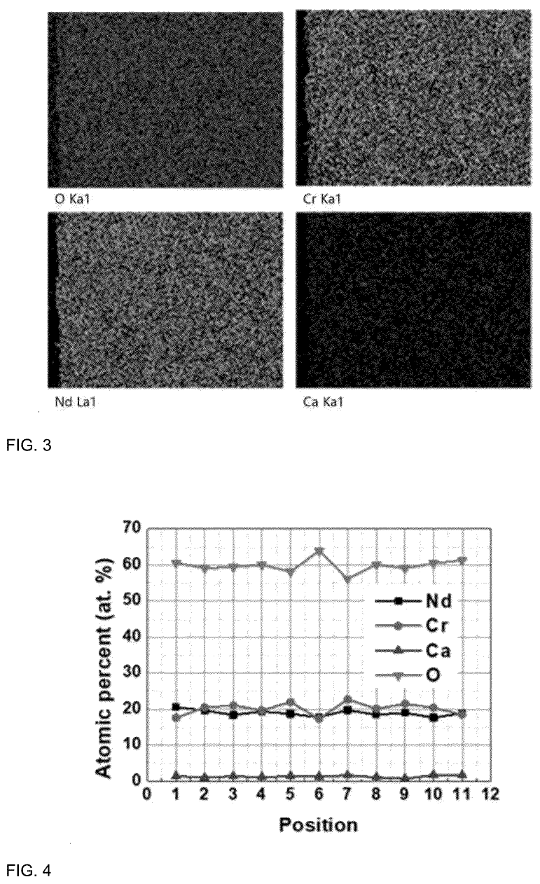

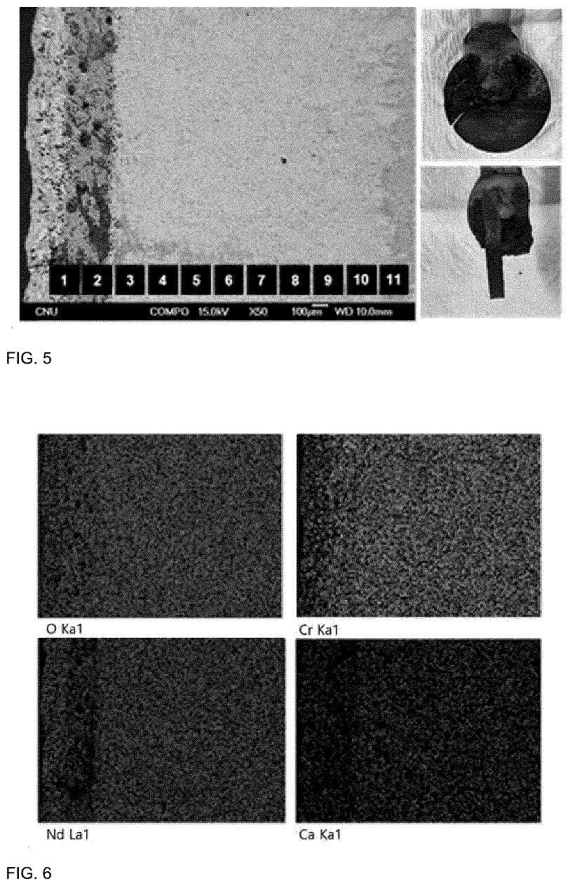

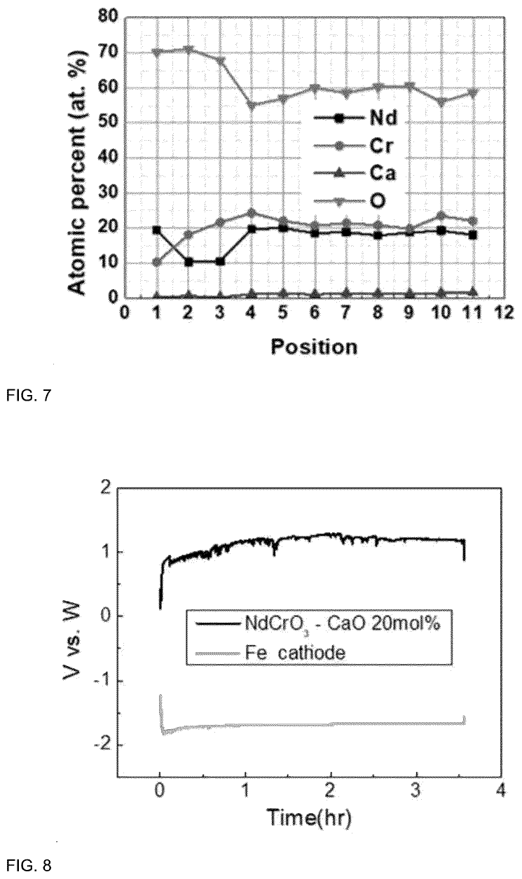

The sintered body manufactured in Comparative Example 2 was prepared as an anode material, and the surface state of the anode material before and after electrowinning under the following conditions was photographed using a scanning electron microscope, with the results shown in FIGS. 2 and 5. In addition, energy dispersive X-ray spectroscopy (EDS) of the anode material before and after electrowinning was performed, with the results shown in FIGS. 3 and 4 and in FIGS. 6 and 7.

### [Electrowinning Conditions]

Electrolyte and raw material composition: 35.4 wt % of LiF, 64.6 wt % of NdF₃, 2 wt % of Nd₂O₃, a total of 1632 g
Cathode material: Fe rod
Reference electrode: W (tungsten) wire
Crucible: Stainless steel crucible
Process temperature: 900° C.
Atmosphere: Ambient atmosphere (air at STP)
Electrolyte current density: 100, 150 mA/cm²

Referring to the results, the anode material of Comparative Example 2 before and after electrowinning had a good dispersion state of the compound having the perovskite structure and the dopant elements (Nd₂, Cr, Ca, O), providing for a likelihood that the dispersion state will also be good in the testing Examples.

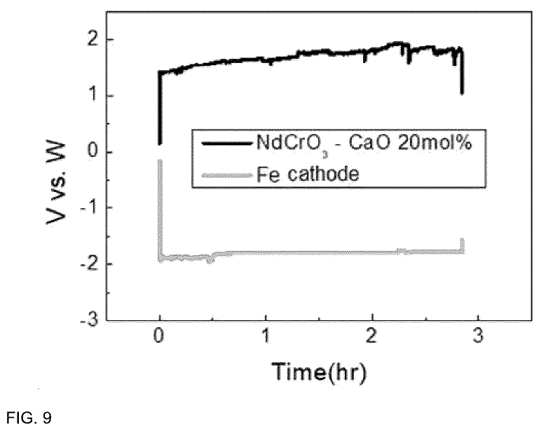

The anode and cathode voltage behaviors at a current density of 100 mA/cm² and a current density of 150 mA/cm² in electrowinning using the anode material of Comparative Example 2 are shown in FIGS. 8 and 9.

The anode potential was maintained for a predetermined electrowinning process time, providing for a likelihood that a good anode potential will also be maintained in Examples.

As is apparent from the foregoing, a sintered body is manufactured by adding a specific dopant to a compound having a perovskite structure followed by sintering. When the sintered body is applied as an anode material for electrowinning a target metal, substantial inertness and excellent electrical conductivity can be exhibited, a stable anode potential and mechanical strength can be maintained, and high resistance to electrochemical stress can be obtained.

In addition, based on the sintered body being applied as an anode material for electrowinning, carbon dioxide emissions can be greatly reduced compared to a graphite anode, which can increase and/or contribute to carbon neutrality goals.

Further, based on the sintered body being applied as an anode material for electrowinning, the replacement cycle can be extended due to the low consumption rate, maintenance costs can be reduced, and process efficiency can increase, which provides an overall decrease in energy demand/consumption.

It should be understood that the effects of the present disclosure are not limited to the foregoing, and that it is inclusive of all effects that can be inferred from the description of the present disclosure.

Although various aspects have been described, those skilled in the art will appreciate that the present disclosure may be embodied in other specific forms and variations without changing the technical spirit, necessary structures, and/or essential features thereof. Thus, the embodiments described above should be understood to be non-limiting and illustrative in every way.

What is claimed is:

1. A sintered body comprising a compound having a perovskite structure and a dopant.

2. The sintered body of claim 1, wherein the sintered body exhibits an electrical conductivity of 800 S/m or more at 900° C.

3. An electrode material comprising the sintered body of claim 2.

4. The sintered body of claim 1, wherein the compound having the perovskite structure comprises:
a first metal comprising one or more of scandium, yttrium, lanthanum, cerium, praseodymium, neodymium, promethium, samarium, europium, gadolinium, terbium, dysprosium, holmium, erbium, thulium, ytterbium, or lutetium,
a second metal comprising at least one transition metal different from the first metal, and
oxygen.

5. The sintered body of claim 4, wherein the second metal comprises one or more of chromium, manganese, iron, ruthenium, or cobalt.

6. The sintered body of claim 1, wherein the dopant comprises a first dopant and a second dopant, wherein the first dopant comprises an alkali metal oxide, and the second dopant comprises an alkaline earth metal oxide.

7. The sintered body of claim 6, wherein the alkali metal oxide comprises one or more of lithium oxide (Li₂O), sodium oxide (Na₂O), or potassium oxide (K₂O); and the alkaline earth metal oxide comprises one or more of calcium oxide (CaO), beryllium oxide (BeO), or magnesium oxide (MgO).

8. The sintered body of claim 6, wherein a molar amount of the first dopant is 0.5 mol % to 7 mol %, and a molar amount of the second dopant is 10 mol % to 25 mol %, each based on a total of 100 mol % of the sintered body.

9. The sintered body of claim 1, wherein the sintered body has electrical conductivity of 1,000 S/m or more at 900° C.

10. An electrode material adapted for electrowinning neodymium, the electrode material comprising a sintered body comprising a compound having a perovskite structure comprising neodymium; an alkali metal oxide; and an alkaline earth metal oxide.

11. A method of manufacturing a sintered body, comprising:
providing a compound having a perovskite structure;
adding a first dopant and a second dopant to the compound having the perovskite structure to provide a mixture; and
molding and sintering the mixture to form the sintered body.

12. The method of claim 11, wherein the compound having the perovskite structure comprises
a first metal comprising one or more of scandium, yttrium, lanthanum, cerium, praseodymium, neodymium, promethium, samarium, europium, gadolinium, terbium, dysprosium, holmium, erbium, thulium, ytterbium, or lutetium,
a second metal comprising at least one transition metal different from the first metal, and
oxygen.

13. The method of claim 11, wherein the first dopant comprises an alkali metal oxide, and the second dopant comprises an alkaline earth metal oxide.

14. The method of claim 13, wherein the alkali metal oxide comprises one or more of lithium oxide (Li₂O), sodium oxide (Na₂O), or potassium oxide (K₂O); and the alkaline earth metal oxide comprises one or more of calcium oxide (CaO), beryllium oxide (BeO), or magnesium oxide (MgO).

15. The method of claim 11, wherein the first dopant is added in an amount such that a molar amount of the first dopant is 0.5 mol % to 7 mol % based on a total of 100 mol % of the sintered body, and the second dopant is added in an amount such that a molar amount of the second dopant is 10 mol % to 25 mol % based on a total of 100 mol % of the sintered body.

16. The method of claim 11, wherein the sintering is performed at a temperature of 1500° C. to 1700° C.

17. The method of claim 11, further comprising hot-pressing the sintered body after sintering.

18. A method of electrowinning a metal, comprising:
preparing a device comprising a first electrode comprising the sintered body of claim 1, a second electrode facing the first electrode, an electrolyte in contact with the first electrode and the second electrode, wherein the electrolyte comprises a target metal-containing material; and
electrodepositing the target metal onto the second electrode by application of a voltage difference between the first electrode and the second electrode.

19. The method of claim 18, wherein the target metal-containing material is neodymium oxide (Nd₂O₃), and the electrolyte comprises neodymium fluoride (NdF₃) and at least one or more of lithium fluoride (LiF), barium fluoride (BaF₂), and/or calcium fluoride (CaF₂).

20. The method of claim 18, wherein a temperature of the electrolyte during electrodepositing is 1000° C. or less.
